(19) United States
(12) Patent Application Publication
(10) Pub. No.: US 2016/0188833 A1
(43) Pub. Date: Jun. 30, 2016

(54) Supportive Care Severity of Illness Score Component for Acute Care Patients

(71) Applicant: CERNER INNOVATION, INC., Kansas City, KS (US)

(72) Inventor: Andrew A. Kramer, Leesburg, VA (US)

(21) Appl. No.: 14/585,951

(22) Filed: Dec. 30, 2014

(51) Int. Cl. G06F 19/00

(52) U.S. Cl. CPC G06F 19/3431; G06F 19/322

(57) ABSTRACT

Systems, methods, and computer storage media are provided for determining a patient's severity of illness score (pSIS) for a patient admitted to an acute care facility. Data is received corresponding to medical support a patient is receiving from an electronic medical record associated with the patient admitted to an acute care healthcare facility. The data is associated with support variables present in a patient upon admission or administered to the patient within an initial time period from admission. Support variables include both pharmaceutical-type variables and medical device-type variables. Weights are assigned to each support variable associated with the patient. A patient's pSIS is determined by summing the weights. The pSIS accounts for effects that medical support a patient is receiving has on the patient's physiology.

### CROSS-REFERENCE TO RELATED APPLICATION

This application having attorney docket number CRNI.224762 is related by subject matter to U.S. patent application Ser. No. ______, filed Dec. 30, 2014, having attorney docket number CRNI.219169, entitled “PHYSILOGIC SEVERITY OF ILLNESS SCORE FOR ACUTE CARE PATIENTS.” The entirety of the aforementioned application is incorporated by reference herein.

### BACKGROUND

Upon admission to an acute care facility, such as an Intensive Care Unit (ICU), Step-Down Unit (SDU), or general medical-surgical floor, predictive methodologies are used to quantify a patient's severity of illness (pSIS) and to estimate their in-facility mortality risk. These predictive methodologies provide health care industry stakeholders with normalized metrics by comparing derived predictive score values with observed outcomes. For example, health care agencies and the general public may use predictive score data for inter-ICU performance comparisons while researchers may use predictive score data to evaluate experimental therapies.

One such predictive methodology is the Acute Physiology and Chronic Health Evaluation (APACHE®) that is based on the view that the core mission of intensive care is to treat disease and maintain physiological homeostasis. A central metric of the APACHE® predictive methodology is the APACHE® score measuring a patient's SOI during the initial twenty-four hour period following the patient's admission to the ICU. The APACHE® score is a composite of three components including the Acute Physiology Score (APS), co-morbid conditions, and the effects of age. The three components are each weighted according to their relative impact on the patient's SOI.

These three components of the APACHE® score are used in over seventy logistic and/or linear regression models that form the APACHE® predictive methodology. A result of one such model provides an estimation of a patient's mortality risk prior to being discharged from the acute care facility. This logistic regression model involves 143 physiological variables, including those in the APS component, age, seven concomitant chronic conditions, the period of time between hospital and ICU admissions, 116 diagnostic categories, the admission source, and five additional clinical variables.

Existing predictive methodologies quantify a pSIS utilizing various components that are largely based on the patient's physiology (e.g. APACHE®'s APS component), age, and/or present comorbidities. While a patient's physiology, age, and present comorbidities are important contributory factors, they are not the only factors that influence the patient's clinical state. A predictive methodology with an adjustment component that accounts for factors that impact a patient's physiology is needed. Predictive scores from such predictive methodologies would be useful to avoid misjudging a patient's severity of illness by not accounting for these other factors that affect the patient's physiologic state.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In various embodiments, methods, systems, and computer storage media are performing a method in a clinical computing environment for determining a patient's severity of illness score (pSIS) for patients admitted to an acute care healthcare facility. Data corresponding to medical support is received from an electronic medical record associated with a patient admitted to an acute care healthcare facility. The data is not required to correspond to physiologic components collected in or associated with an intensive care unit. Weights are assigned to each support variable associated with the patient. Weights associated with each support variable derived using logistic regression coefficients associated with each support variable. A pSIS is for the patient is determined by summing the weights. The pSIS accounts for the effects due to medical support a patient is receiving, such as pharmaceuticals, medical devices, and/or medical procedures, has on a patient's physiology.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram of an exemplary system for determining a pSIS for a patient admitted to an acute care facility, in accordance with embodiments of the present invention;

FIG. 3 is a flow diagram showing an exemplary method for determining a pSIS for a patient admitted to an acute care healthcare facility, in accordance with various embodiments of the present invention;

FIG. 4 is a flow diagram showing an exemplary method for determining an overall severity of illness score, using a pSIS as a component, in accordance with various embodiments of the present invention; and

FIG. 5 is a flow diagram showing an exemplary method for predicting an outcome for a patient admitted to an acute care healthcare facility using a pSIS as a variable in predictive equations, in accordance with various embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Accordingly, various aspects of the technology described herein are generally directed to methods, systems, computer storage media useful for determining a pSIS for a patient admitted to an acute care healthcare facility that accounts for the effects due to medical support the patient is receiving, such as pharmaceuticals, medical devices, and/or medical procedures, has on a patient's physiology. Various embodiments of the present invention are directed to determining a pSIS for a patient by summing weights assigned to support variables associated with the patient. In these embodiments, data corresponding to medical support are received from an electronic medical record associated with a patient. In some embodiments, an electronic medical record associated with a patient includes data from all admissions to an acute care facility. In these embodiments, the pSIS derived using such data could be used with a broader scope of patients admitted to the acute care facility, not just to an ICU. In an embodiment, support variables included one or more of anti-arrhythmic medication, antibiotics medication given intravenously, inotrope medication, insulin medication given intravenously, vasopressor medication given intravenously, dialysis, intubation, invasive mechanical ventilation, non-invasive mechanical ventilation, or pacemaker implanted in the patient.

### Exemplary Computing Environment

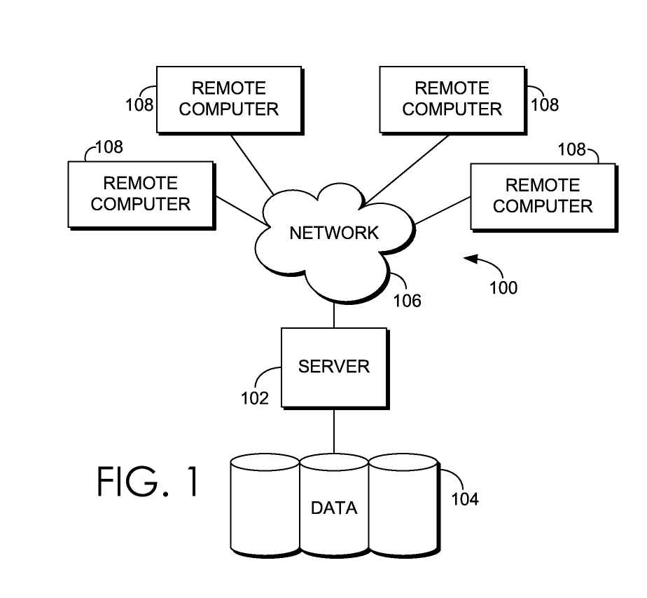

Having briefly described an overview of embodiments of the invention, an exemplary computing environment suitable for use in implementing embodiments of the present invention is described below. Referring to the figures in general and initially to FIG. 1 in particular, an exemplary computing environment (e.g., medical-information computing-system environment) with which embodiments of the present invention may be implemented is depicted and designated generally as computing environment 100. Computing environment 100 is merely an example of one suitable computing environment and is not intended to suggest any limitation as to the scope of use or functionality of the invention. Neither should computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices). As used herein, “in-facility mortality”, “mortality probability”, and “probability of mortality” are used interchangeable to define the probability of a patient's death prior to discharge from an acute care facility.

With continued reference to FIG. 1, computing environment 100 includes a computing device in the form of control server 102. Exemplary components of control server 102 comprise a processing unit, internal system memory, and a suitable system bus for coupling various system components, including data store 104, with control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Control server 102 typically includes therein, or has access to, a variety of computer-readable media. Computer-readable media can be any available media that might be accessed by control server 102, and includes volatile and nonvolatile media, as well as, removable and non-removable media. By way of example, and not limitation, computer-readable media may comprise computer storage media and communication media. Computer storage media does not comprise, and in fact explicitly excludes, signals per se.

Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Control server 102 might operate in a computer network 106 using logical connections to one or more remote computers 108. Remote computers 108 might be located at a variety of locations in a medical or research environment or at healthcare facilities, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians or healthcare providers may comprise a treating physician or physicians; specialists such as surgeons, radiologists, cardiologists, and oncologists; emergency medical technicians; physicians' assistants; nurse practitioners; health coaches; nurses; nurses' aides; pharmacists; dieticians; microbiologists; laboratory experts; laboratory technologists; genetic counselors; researchers; veterinarians; students; and the like.

Remote computers 108 may also be physically located in nontraditional medical care environments so that the entire healthcare community might be capable of integration on the network. Remote computers 108 may include personal computers, servers, routers, network PCs, peer devices, other common network nodes, or the like and might comprise some or all of the elements described above in relation to control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108.

For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization, a healthcare provider, and/or a user at a healthcare facility might enter commands and information into the control server 102 or convey the commands and information to control server 102 via one or more remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to control server 102. In addition to a monitor, control server 102 and/or remote computers 108 might comprise other peripheral output devices, such as speakers and a printer.

Although many other internal components of control server 102 and remote computers 108 are not shown, such components and their interconnection are well known. Accordingly, additional details concerning the internal construction of control server 102 and remote computers 108 are not further disclosed herein.

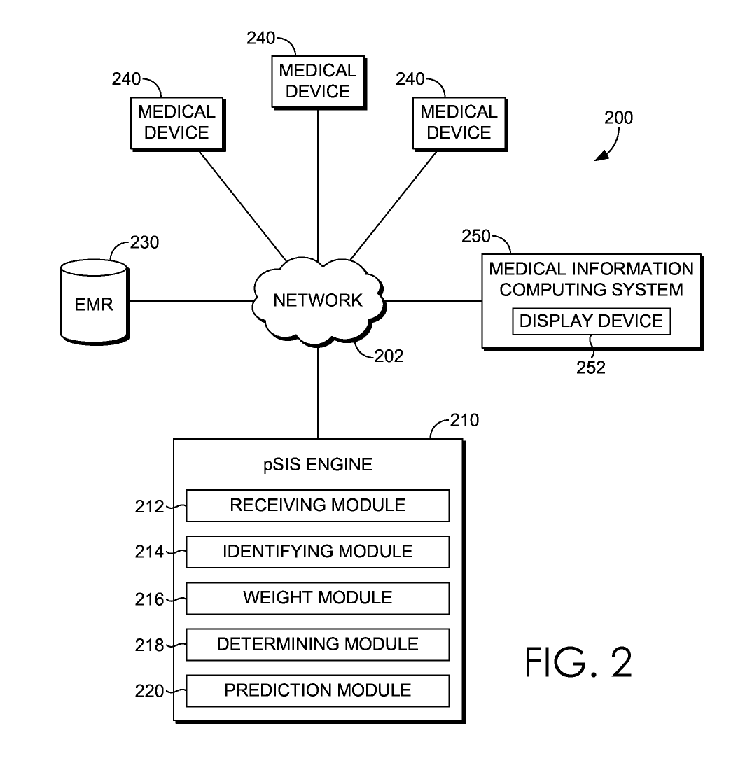

Referring now to FIG. 2, a block diagram is provided illustrating an exemplary system 200 in which a pSIS engine 210 is shown interfaced with medical information computing system 250 in accordance with an embodiment of the present invention. Medical information computing system 250 may be a comprehensive computing system within a clinical environment similar to the exemplary computing system 100 discussed above with reference to FIG. 1.

Medical information computing system 250 includes a clinical display device 252. In one embodiment, clinical display device 252 is configured to display a pSIS score as determined by pSIS engine 210. In another embodiment, clinical display device 252 is configured to receive input from the clinician, such as selection of a patient type, unit, facility information, or information associated with the patient, and the like. In another embodiment, medical information computing system 250 receives inputs, such as information associated with a patient, from one or more medical devices 240.

In general, pSIS engine 210 is configured to determine a pSIS for a patient admitted to an acute care facility. As shown in FIG. 2, pSIS engine 210 includes, in various embodiments, receiving module 212, identifying module 214, weight module 216, determining module 218, and prediction module 220.

Receiving module 212 is configured to receive data corresponding to medical support from one or more electronic medical records associated with a patient admitted to an acute care facility. The data is associated with medical support present in a patient when admitted and medical support administered to the patient within an initial time period from admission. For example, the initial time period is within twenty-four hours of admission. In an embodiment, the data originates from one or more sources including a clinician's notes, laboratory results, radiologic results, pharmacy records, insurance records, and the like. In an embodiment, receiving module 212 is further configured to receive a data set corresponding to medical support from an electronic medical record associated with a group of patients admitted to acute care facilities. In another embodiment, the group of patients admitted to acute care facilities includes patients admitted to all levels of care within acute care facilities.

Identifying module 214 is configured to identify support variables associated with the patient in the data received by receiving module 212. The support variables associated with the patient are identified using medical codes. In an embodiment, the medical codes used by identifying module 214 include one or more of the following: diagnostic codes, billing codes, procedural codes, topographical codes, pharmaceutical codes, or pharmaceutical names. In another embodiment, the diagnostic codes include International Classification of Diseases (ICD) codes.

In another embodiment, the procedural codes include one or more of the following: Current Procedural Terminology (CPT) codes, Health Care Procedure Coding System (HCPCS) codes, Chinese Classification of Health Interventions (CCHI) codes, International Classification of Procedures in Medicine (ICPM) codes, or International Classification of Health Interventions (ICHI) codes. In another embodiment, the pharmaceutical codes include one or more of the following: Anatomical Therapeutic Chemical (ATC) codes or National Drug Codes (NDCs). In another embodiment, the topographical codes include one or more of the following: International Classification of Diseases for Oncology (ICD-O) codes, or Systematized Nomenclature of Medicine (SNOMED) codes.

Weight module 216 is configured to assign weights to each support variable. Clinical consideration of the types of pharmaceuticals and medical procedures that have the most impact on a patient's physiology is used to identify candidate support variables for inclusion in an initial pSIS regression model. In an embodiment, clinical consideration identifies fourteen candidate support variables for inclusion in an initial pSIS regression model as shown below in Table 1.

TABLE 1

| Candidate Support | |
|---|---|
| Component | Derivation |
| Anti-Arrhythmics | Generic drug names = [Adenosine, Amiodarone, Bretylium, Digoxin, Diltiazem, |
| | Disopyramide, Dofetilide, Dronedarone, Esmolol, Flecainide, Ibutilide, Lidocaine, |
| | Mexiletine, Moricizine, Procainamide, Propafenone, Propranolol, Quinidine, Sotalol, |
| | Tocainide, Verapamil] |
| Antibiotics IV | List of generic drug names in Table 2, given intravenously |
| Balloon Pump | CPT code = 37.61 |
| Dialysis | CPT codes = [38.95, 39.27, 39.43, 39.43, 39.95, 54.98] |
| Inotrope | Multum category = “Inotrope” |
| Insulin IV | Receiving insulin intravenously |
| Intubated | CPT code = 93.91 |
| Mechanical Ventilation | CPT codes = [96.70, 96,71, 96.72] |
| (invasive) | |
| Mechanical Ventilation | CPT code = 93.90 |
| (non-invasive) | |
| Neuromuscular Blockers | NDC drug classification = contains “neuromusc”, given intravenously |
| IV | |
| Pacemaker | CPT codes for pacemaker implanted = [00.50, 0053, 34.85, 37.80, 37.85, 37.86, 37.87, |
| | 37.89, 39.64, 89.45, 89.46, 89.47, 89.48] |
| Sedative IV | Generic drug names = [Droperido1, Etomidate, Ketamine, Propofo1], given intravenously |
| Tracheostomy | CPT codes for tracheal airway device = [31.1, 31.2, 31.74, 96.55, 97.23, 97.37] |
| Vasopressor IV | Generic drug names = [Vasopressin, Norepinephrine, Epinephrine, Isoproterenol, |
| | Dobutamine, Dopamine, Ephedrine, Mephentermine, Metaraminol, Methoxamine, |
| | Phenylephrine], given intravenously |

In an embodiment, the Antibiotics IV candidate support variable of Table 1 includes the list of generic antibiotic drugs given intravenously shown below in Table 2.

TABLE 2

| | | | |
|---|---|---|---|
| Adamantane | Antiviral Chemokine | Lincomycin Derivatives | Penicillins |
| Antivirals | Receptor Antagonist | | |
| Amebicides | Antiviral | Macrolide Derivatives | Polyenes |
| | Combinations | | |
| Aminoglycosides | Antiviral Interferons | Macrolides | Protease Inhibitors |
| Aminopenicillins | Azole Antifungals | Miscellaneous Antibiotics | Purine Nucleosides |
| Aminosalicylates | Beta-Lactamase | Miscellaneous Antifungals | Quinolones |
| | Inhibitors | | |
| Anthelmintics | Carbapenems | Miscellaneous Antimalarials | Rifamycin Derivatives |
| Antifungals | Cephalosporins | Miscellaneous | Second Generation |
| | | Antituberculosis Agents | Cephalosporins |
| Antimalarial Agents | Echinocandins | Miscellaneous Antivirals | Streptomyces |
| | | | Derivatives |
| Antimalarial | Cephalosporins | Natural Penicillins | Sulfonamides |
| Combinations | | | |
| Antimalarial | Glycopeptide | Neuraminidase Inhibitors | Tetracyclines |
| Quinolines | Antibiotics | | |
| Antipseudomonal | Glycylcyclines | Nicotinic Acid Derivatives | Third Generation |
| Penicillins | | | Cephalosporins |
| Antituberculosis | Integrase Strand | Nnrtis | Urinary Anti-Infectives |
| Agents | Transfer Inhibitor | | |
| Antituberculosis | Ketolides | Nrtis | |
| Combinations | | | |
| Antiviral Agents | Leprostatics | Penicillinase Resistant | |
| | | Penicillins | |

A stepwise logistic regression variable selection process is used to identify which of the candidate support variables were significant predictors of in-facility mortality for inclusion in a final pSIS regression model. In an embodiment, the stepwise logistic regression process is a backward stepwise elimination process. The stepwise regression process assessed the initial pSIS score regression model against a data set corresponding to medical support from an electronic medical record associated with a group of patients admitted to an acute care hospital.

In an embodiment, the group of patients comprises patients admitted to all levels of care within an acute care hospital (e.g. general medical-surgery floor, intermediate care floor, and an ICU). In another embodiment, data associated with patients identified as having a probability of in-facility mortality of below a minimal threshold is excluded from the data set. For example, the minimal threshold may be a probability of in-facility mortality of around zero (e.g. females admitted exclusively for labor and delivery).

In another embodiment, a data set includes, for each patient in the group of patients, data associated with the presence (or absence) of any of the fourteen candidate support variables upon a particular patient's admission or administered to the particular patient within an initial time period from admission. For example, the initial time period from admission is twenty-four hours. In another embodiment, a data set includes, for each patient in the group of patients, data associated with a particular patient's hospital discharge disposition. For example, the particular patient's hospital discharge disposition may include discharge to a different level of care, discharge to self-care, discharge to long term care, in-facility mortality, and the like.

The stepwise logistic regression process identifies candidate support variables that do not achieve statistical significance for removal by removing candidate support variables that did not receive a p-score of less than 0.10. In an embodiment, as a result of a stepwise logistic regression process, the following candidate support variables were identified for removal from a final pSIS regression model: Balloon pumps; Neuromuscular Blockers IV; Sedative IV; and Tracheostomy. Consequently, ten candidate support variables were identified for inclusion in a final pSIS regression model. In an embodiment, ten candidate support variables identified for inclusion in a final pSIS regression model included five pharmaceutical-type support variables and five medical device-type support variables.

The final pSIS regression model used to derive a logistic regression coefficient (β) for each support variable included in a pSIS, is shown in Equation 1:

$$\begin{matrix}Equation 1 & \\ y = α + {β}_{1} {X}_{1} + {β}_{2} {X}_{2} + … {β}_{10} {X}_{10} = log ( \frac{probability of mortality}{1 - probability of mortality} ) & ( 1 )\end{matrix}$$

Where:
α=an intercept
β₁-β₁₀=logistic regression coefficients for each of the corresponding support variables
X₁-Xᵢ=binary variables indicating the presence or absence of the corresponding support variables

As shown in Equation 1, the final pSIS regression model used to derive logistic regression coefficients for each support variable may be used to predict a patient's mortality probability. Inserting the logistic regression coefficients derived in Equation 1, weights for each of the support variables included in a pSIS may be derived as shown in Equations 2 and 3:

Equations 2-3:

γᵢ=sign(βᵢ)*e^{|β}^{ᵢ}^{|} (2)

weightᵢ=round(γᵢ,0.1) (3)
Where:
i=denotes a particular support variable under consideration
sign(βᵢ)=1 if βᵢ is positive; or
   −1 if βᵢ is negative
round(γᵢ)=rounding the value of γᵢ to the nearest tenth

For example, the final pSIS regression model shown in Equation 1 derives a logistic regression coefficient for the Anti-Arrhythmic IV support variable of −0.2185. Inserting that logistic regression coefficient in Equations 2 and 3 derives a weight for the Anti-Arrhythmic IV support variable of −1.5. In another example, the final regression model shown in Equation 1 derives a logistic regression coefficient for the Vassopressor IV support variable of 1.3903. Inserting that logistic regression coefficient in Equations 2 and 3 derives a weight for the Vassopressor IV support variable of 4.0.

In an embodiment, weight module 216 derives weights for each support variable using logistic regression coefficients associated with each support variable. The weights used to determine the pSIS are shown in Table 3 below.

TABLE 3

| Support Variable | Coefficient (β) | pSIS Weight |
|---|---|---|
| Anti-arrhythmic | −0.2185 | −1.2 |
| Antibiotic IV | 0.3725 | 1.5 |
| Dialysis | 0.2639 | 1.3 |
| Inotrope | 0.6912 | 2.0 |
| Insulin IV | 0.5363 | 1.7 |
| Intubated | 0.4860 | 1.6 |
| Mechanical Ventilation | 2.0472 | 7.7 |
| (invasive) | | |
| Mechanical Ventilation | 1.1484 | 3.2 |
| (non-invasive) | | |
| Pacemaker | −1.1205 | −3.1 |
| Vasopressor IV | 1.3903 | 4.0 |

As shown above in Table 3, a support variable with a negative valued logistic regression coefficient indicates a negative relationship between a patient's mortality probability and the particular support variable. That is, patients identified as having these negative valued logistic regression coefficients have a decreased probability of in-facility mortality. Alternatively, a support variable with a positive valued logistic regression coefficient indicates a positive relationship between a patient's mortality probability and the particular support variable. That is, patients identified as having these positive valued logistic regression coefficients have an increased probability of in-facility mortality.

Determining module 218 is configured to determine a pSIS score for the patient by summing weights associated with one or more support variables identified by identification module 214 in an electronic medical record associated with the patient using data received by receiving module 212 upon admission or within an initial time period with weights assigned by weight module 216. In embodiments, the initial time period is within twenty-four hours of a patient's admission.

For example, prior to being admitted to a health care facility, a patient previously had a pacemaker inserted. Also, during an initial twenty-four hour period following admission, the patient is placed on non-invasive, mechanical ventilation, such as Bilevel Positive Airway Pressure (BiPap), and receives intravenous (IV) insulin. A pSIS for the patient of this example may be determined as follows: −3.1 weight for the pacemaker+3.2 weight for the BiPap+1.7 weight for the insulin given IV, for a combined score of 1.8. If a multiplier of 10 is used, the pSIS for this patient would be 18.0. In some embodiments a different multiplier may be used.

In some embodiments, the pSIS can be utilized as a component of an overall severity of illness (SOI) score and/or a variable in predictive equations. In these embodiments, such predictive equations may comprise: demographics, other medical conditions diagnosed for a patient, comorbid conditions, additional procedures/medications performed on or in use by a patient, and the like. In these embodiments, additional data corresponding to the physiologic components from the electronic medical record may be received and/or utilized to update a patient's PI score. The additional data may be based on changes associated with the patient that might affect the weight for a particular physiologic component and/or the PI score. The additional data may be based on a clinician's desire to monitor a particular physiologic component or a follow-up measurement for that physiologic component. Similarly, the additional data may be based on a follow-up visit or later admission (i.e., after the initial admission) to the acute care facility.

In some embodiments, prediction module 220 may utilize the pSIS in a predictive equation to predict a likelihood of hospital mortality for the patient. In another embodiment, prediction module 220 may utilize the pSIS in a predictive equation to predict a length of stay in the acute care facility for the patient. In other embodiments, prediction module 220 may utilize the pSIS in a predictive equation to predict any of a plurality of outcomes for the patient including: duration of mechanical ventilation, location of stay (e.g. level of care), readmission risk, discharge destination, and the like.

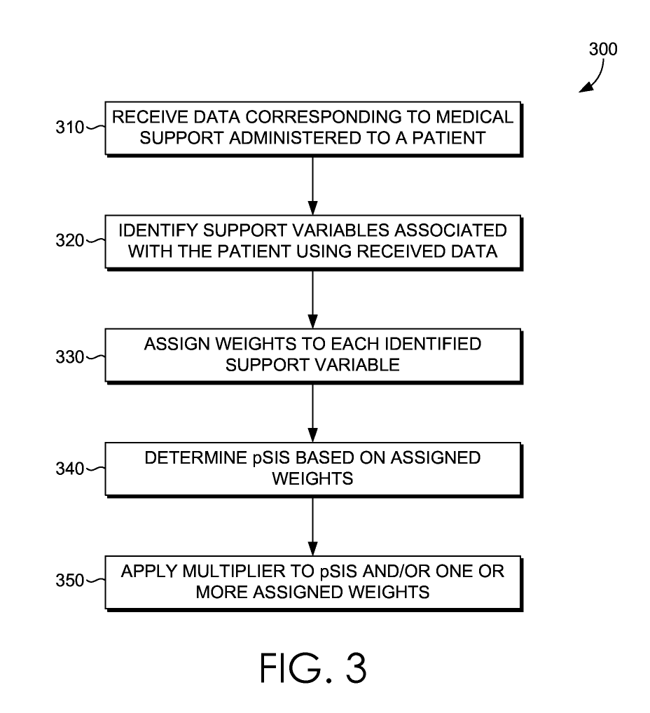

Turning now to FIG. 3, a flow diagram is provided illustrating a method 300 for determining a pSIS for a patient admitted to an acute care healthcare facility, in accordance with various embodiments of the present invention. Initially, in step 310 data corresponding to medical support administered to a patient is received from an electronic medical record associated with the patient admitted to an acute care healthcare facility. In an embodiment, support variables include one or more of anti-arrhythmic medication, antibiotics medication given intravenously, inotrope medication, insulin medication given intravenously, vasopressor medication given intravenously, dialysis, intubation, invasive mechanical ventilation, non-invasive mechanical ventilation, or pacemaker implanted in the patient.

In step 320, support variables associated with the patient are identified. Medical classification codes may be utilized, as discussed above with respect to FIG. 2, to analyze the received data to identify support variables associated with the patient. In step 330, weights are assigned to each identified support variable. The weights are derived based on a deviation from normal. Logistic regression coefficients may be utilized, as discussed above with respect to FIG. 2, to assign weights to each support variable. In another embodiment, the one or more support variables and associated weights for each that are used to determine the pSIS are shown in Table 3 above.

As shown by Table 3, administering some medications and/or medical procedures may result in a negative weight being assigned. This accounts for evidence that these pharmaceuticals and/or medical procedures correspond with a reduced mortality risk. In the embodiment of Table 3, five support variables used to determine the pSIS are pharmaceutical-type support variables and five support variables are medical procedure-type support variables. In other embodiments, different combinations of pharmaceutical-type support variables and medical procedure-type support variables may be used.

In step 340, a pSIS is determined for the patient by summing the derived weights. In some embodiments, the pSIS can be utilized as a component of an overall severity of illness (SOI) score and/or a variable in predictive equations. In step 350, a multiplier may be applied to the pSIS and/or one or more of the weights associated with the identified support variables to ordinalize the pSIS for use with other physiologic index scores.

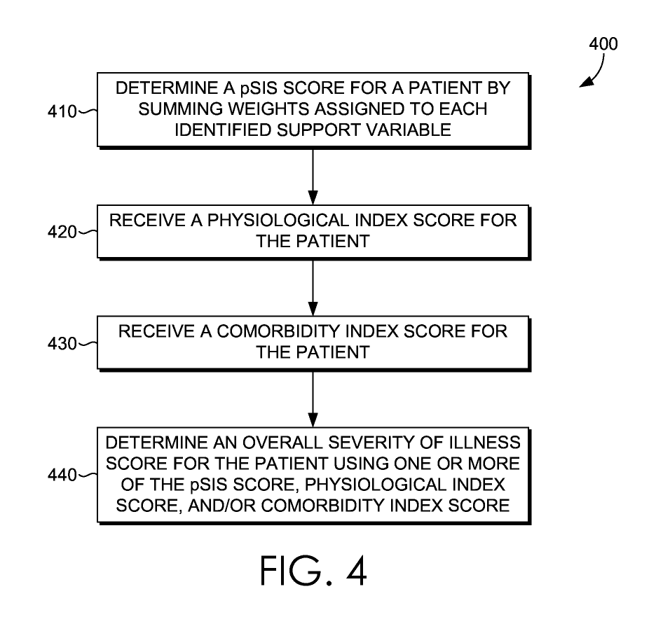

Turning now to FIG. 4, a flow diagram is provided illustrating a method 400 for determining an overall SOI score, using a pSIS as a component, for a patient admitted to an acute care healthcare facility, in accordance with various embodiments of the present invention. As discussed above, a pSIS, may be utilized as a component of an overall SOI score for the patient. Initially, in step 410, a pSIS is determined in accordance with method 300.

In an optional step 420, a physiologic index (PI) score for the patient is received determined, and/or updated. When used with a pSIS as a component of an overall SOI score for a patient, the PI score is used to track the patient's physiological state using received data corresponding to physiologic measures of interest. Data corresponding to physiologic components is received from an electronic medical record associated with a patient admitted to an acute care healthcare facility. The data is not required to correspond to physiologic components collected in or associated with an intensive care unit. Weights are assigned to each physiologic component. The weights are derived based on a deviation from normal. A PI score for the patient is determined by summing the weights. Additional data corresponding to the physiologic components may be received from the electronic medical record. The additional data may be utilized to update the weights and determine an updated PI score for the patient that may also be utilized to track a progress of the patient.

In one embodiment, seven physiologic measures of interest include four items related to vital sign information used by the APACHE® predictive methodology (Heart Rate (HR), Respiratory Rate (Resp), Temperature (Temp), and Mean Arterial Pressure (MAP)) as well as three items related to common laboratory tests on a blood sample from the patient (Platelet Count, Hematocrit, and Sodium). Similar to APACHE®'s APS component, a PI score includes four vital sign physiologic measures of interest, including the minimum and maximum measured values over a twenty-four hour time period. Unlike the APACHE®'s APS component, the PI score utilizes each vital sign's median measured value over a time period, which might improve during that time frame. In an embodiment, the time period may be twenty-four hours. Notably, the PI score utilizes a Platelet Count measurement that is not included by the APACHE® methodology. Platelet count imparts information on the body's ability to clot a wound. Too small a value implies inability to heal a wound, while too large a value indicates the possibility of a blood clot. Platelet count is considered an important laboratory test that should be included in a measure of physiologic derangement.

In some embodiments, the four physiologic measures of interest available via vital sign measurements are utilized with the cut-points (in parenthesis) and weights (before parenthesis) as shown below in Table 4. In these embodiments, the received data includes data associated with a patient's vital sign measurements. In embodiments, weights are assigned to a minimum, median, and maximum measured value for each of the vital sign measurements. In embodiments, weights associated with vital sign measurements are derived based on a deviation from normal for minimum, median, and maximum measured values over a twenty-four hour time period following the patient's admission and subsequently updated as new values are recorded.

TABLE 4

| | | | | | | | |
|---|---|---|---|---|---|---|---|
| | | 5 | Highest HR | 5 | 9 | 16 | |
| | | (<64 min⁻¹) | 0 | (95-102 min⁻¹) | (103-138 min⁻¹) | (>138 min⁻¹) | |
| | | | (64-94 min⁻¹) | | | | |
| | | 9 | Lowest HR | 2 | 13 | | |
| | | (<48 min⁻¹) | 0 | (77-100 min⁻¹) | (>100 min⁻¹) | | |
| | | | (48-76 min⁻¹) | | | | |
| | | 3 | Median HR | 3 | 5 | 8 | 11 |
| | | (<57 min⁻¹) | 0 | (72-80 min⁻¹) | (81-87 min⁻¹) | (88-111 min⁻¹) | (>111 min⁻¹) |
| | | | (64-94 min⁻¹) | | | | |
| | | 6 | Highest MAP | 1 | 9 | | |
| | | (<76.00 mmHg) | 0 | (93.67-136.32 mmHg) | (>136.32 mmHg) | | |
| | | | (76.00-93.66 mmHg | | | | |
| 18 | 10 | 5 | Lowest MAP | 5 | | | |
| (<53.00 | (53.00-70.32 | (70.33-82.66 mmHg) | 0 | (>103.99 mmHg) | | | |
| mmHg) | mmHg) | | (82.67-103.99 mmHg | | | | |
| | 13 | 4 | Median MAP | 10 | 7 | | |
| | (<68.00 mmHg) | (68.00-81.66 mmHg) | 0 | (88.72-115.16 mmHg) | (>115.16 mmHg) | | |
| | | | (81.67-88.71 mmHg | | | | |
| | 15 | 2 | Highest Temp. | 3 | 9 | | |
| | (<36.11° C.) | (36.11-36.79° C.) | 0 | (37.07-38.44° C.) | (>38.44° C.) | | |
| | | | (36.80-37.06° C.) | | | | |
| | | 14 | Lowest Temp. | 2 | 4 | 5 | |
| | | (<35.11° C.) | 0 | (36.00-36.12° C.) | (36.13-36.99° C.) | (>36.99° C.) | |
| | | | (35.11-35.99° C.) | | | | |
| | | 6 | Median Temp. | 2 | 7 | | |
| | | (<36.44° C.) | 0 | (36.62-37.60° C.) | (>37.60° C.) | | |
| | | | (36.44-36.61° C.) | | | | |
| | | 12 | Lowest Resp. | 16 | | | |
| | | (<16 min⁻¹) | 0 | (>19 min⁻¹) | | | |
| | | | (16-19 min⁻¹) | | | | |
| | | 13 | Highest Resp. | 1 | 18 | | |
| | | (<17 min⁻¹) | 0 | (20-23 min⁻¹) | (>23 min⁻¹) | | |
| | | | (17-19 min⁻¹) | | | | |
| | 2 | 1 | Median Resp. | 3 | 14 | | |
| | (<14 min⁻¹) | (14-17 min⁻¹) | 0 | (20-22 min⁻¹) | >22 min⁻¹) | | |
| | | | (18-19 min⁻¹) | | | | |

In some embodiments, the three physiologic measures of interest available via laboratory tests on a blood sample are utilized with the cut-points (in parenthesis) and weights (before parenthesis) as shown below in Table 5. In these embodiments, the received data includes data associated with common laboratory tests on a blood sample taken from the patient. In these embodiments, weights are assigned to a minimum and a maximum measured value for each of the common laboratory tests. In these embodiments, the weights associated with common laboratory test measurements are derived based on a deviation from normal for minimum and maximum measured values over a twenty-four hour time period following the patient's admission and subsequently updated as new values are recorded.

TABLE 5

| | | |
|---|---|---|
| 4 (<27.10%) | Highest Hematocrit | 5 (>41.39%) |
| | 0 (27.10-41.39%) | |
| 6 (<25.50%) | Lowest Hematocrit | 5 (>41.39%) |
| | 0 (25.50-40.89%) | |
| 6 (<125 × 10⁹/L) | Highest Platelet | 4 (>321 × 10⁹/L) |
| | 0 (125-321 × 10⁹/L) | |
| 10 (<119 × 10⁹/L) | Lowest Platelet | 2 (>314 × 10⁹/L) |
| | 0 (119-314 × 10⁹/L) | |
| 5 (<134 mEq/L) | Highest Sodium | 9 (>143 mEq/L) |
| | 0 (134-143 mEq/L) | |
| 11 (<133 mEq/L) | Lowest Sodium | 6 (>142 mEq/L) |
| | 0 (133-142 mEq/L) | |

For example, during an initial twenty-four hour period following admission of a patient to a health care facility, the following physiologic component measurements are received for a patient. The vital sign measurements include: heart rate measured values (maximum=118 min⁻¹, minimum=45 min⁻¹, and median=95 mini; MAP measured values (maximum=110 mmHg, minimum=80 mmHg, and median=92 mmHg), body temperature measured values (maximum=40.0° C., minimum=35.8° C., and median=37.3° C.), and respiratory rate measured values (maximum=17 min⁻¹, minimum=12 min⁻¹, and median=13.7 mini. In this example, the common laboratory test measurements include: platelet count measured values (maximum=350*10⁹/L and minimum=110*10⁹/L), hematocrit measured values (maximum=43% and minimum=40%), and sodium level measured values maximum=144 mEq/L and minimum=133 mEq/L).

Using the weight values provided in the embodiment shown in Table 4, the patient's weights for the maximum, median, and minimum recorded values, respectively, for each vital sign are: heart rate (maximum=9, median=8, and minimum=9); MAP (maximum=1, median=10, and minimum=5); body temperature (maximum=9, median=2, and minimum=0); and respiratory rate (maximum=0, median=2, and minimum=12). Using the weight values provided in the embodiment shown in Table 5, the patient's weights for the maximum and minimum recorded values, respectively, for each common laboratory test are: platelet count (maximum=4 and minimum=10); hematocrit (maximum=5 and minimum=0); and sodium level (maximum=9 and minimum=0). Accordingly, a PI score for this fictional patient, determined by a summation of the weights, would be 95 [heart rate (9+8+9)+MAP (1+10+5)+body temperature (9+2+0)+respiratory rate (0+2+12)+platelet count (4+10)+hematocrit (5+0)+sodium level (9+0)].

In an optional step 430, a comorbidity index (CI) score for the patient is received. When used with a pSIS as a component of an overall SOI score for a patient, the CI score accounts for effects that comorbidities have on a patient's physiology. In embodiments where a CI score is used, the CI score for a patient may be determined by summing weights assigned to one or more comorbidity variables identified in an electronic medical record associated with the patient. Also, in some embodiments, a multiplier may be applied to the summation of weights assigned to the one or more identified comorbidity variables (e.g. summation of weights*10).

In an embodiment, the one or more comorbidity variables and associated weights for each that are used to determine the CI score are shown in Table 6 below. As used in Table 6, CHI refers to one or more of the following comorbidities: acquired immune deficiency syndrome (AIDS), Cirrhosis, Leukemia, Lymphoma, and a prior tissue Transplant received by the patient. The last three rows of Table 6 assign greater weights to provide for cumulative effects on a patient's physiology associated with the patient concurrently being subject to particular combinations of comorbidities.

TABLE 6

| Comorbidity | Weight |
|---|---|
| Bleeding | 4.1 |
| Stroke | 3.5 |
| Heart Fail | 3.2 |
| CHIs | 2.9 |
| Neuromusc | 2.6 |
| Dementia | 2.9 |
| COPD | 2.3 |
| Stroke and Bleeding | additional |
| | 5.3 |
| Stroke and COPD | additional |
| | 2.0 |
| CHIs and Heart Fail | additional |
| | 2.5 |

For example, prior to being admitted to a health care facility, a patient previously experienced a stroke. In addition, the patient is currently experiencing cirrhosis and chronic obstructive pulmonary disease (COPD). A CI score for the patient of this example may be determined as follows: 3.5 weight for the stroke+2.9 weight for CHIs (i.e. the cirrhosis)+2.3 weight for COPD. Furthermore, an additional 2.0 weight would be added to the patient's CI score for the combination of stroke and COPD, making the total points=10.7. If a multiplier of 10 is used, the CI score for this patient would be 107. In some embodiments a different multiplier may be used.

In step 440, an overall SOI score is determined for the patient by summing the derived pSIS and one or more of the PI score and/or the CI score. Additionally, in some embodiments, a multiplier may be applied to the summation of derived component scores (e.g. pSIS, PI score, and/or CI score) or to one or more of the derived components scores prior to summation. In these embodiments, the multiplier may serve to normalize the overall SOI score to a range of 0 to 100. Additionally or in the alternative, prior to summation, a pSIS multiplier may be applied to a derived pSIS score, a PI multiplier may be applied to a derived PI score, and/or an CI multiplier may be applied to a derived CI score. For example, a pSIS multiplier of 0.25 may be applied to a derived pSIS, a PI multiplier of 0.65 may be applied to a derived PI score, and/or a CI multiplier of 0.20 may be applied to a derived CI score. In this example, an overall SOI score could be determined as: 0.25*determined pSIS+0.65*determined PI score+0.20*determined CI score.

Furthermore, if one or more derived component scores falls below (or above) an associated threshold value, a predetermined replacement score may be substituted for the derived component score. For example, a replacement pSIS of −20 may be substituted for a derived pSIS that is less than −20, a PI replacement score of 160 may be substituted for a derived PI score that is greater than 160, and/or a CI replacement score of 180 may be substituted for a derived CI score that is greater than 180. In an embodiment, an overall severity of illness replacement score of 100 may be substituted for an overall severity of illness derived score greater than 100. Using the example scores for the fictional patients above with a derived pSIS of 18, a derived PI score of 95, and a derived CI score of 107, the fictional patient's overall SOI score may be 87.65 (˜0.25*18+0.65*95+0.20*107).

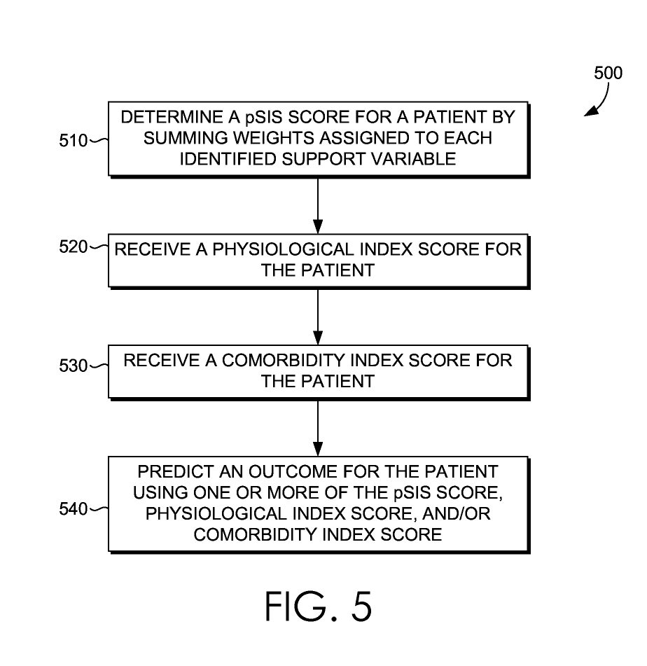

Turning now to FIG. 5, a flow diagram is provided illustrating a method 500 for predicting an outcome for a patient admitted to an acute care healthcare facility using a pSIS as a variable in predictive equations, in accordance with various embodiments of the present invention. As discussed above, a pSIS, may be utilized as a variable in a predictive equation to predict an outcome for the patient. Initially, in step 510, a pSIS is determined in accordance with method 300.

In an optional step 520, a physiologic index (PI) score for the patient is received, determined and/or updated. When used with a pSIS as a variable in equations to predict an outcome for a patient, the PI score is used to track the patient's progress using received data corresponding to physiologic measures of interest. Data corresponding to physiologic components is received from an electronic medical record associated with a patient admitted to an acute care healthcare facility. The data is not required to correspond to physiologic components collected in or associated with an intensive care unit. Weights are assigned to each physiologic component. The weights are derived based on a deviation from normal. An example of the physiologic components and associated weights for each that are used to determine the PI score are shown in Tables 4 and 5 above.

In an optional step 530, a comorbidity index (CI) score for the patient is received. When used with a pSIS as a variable in equations to predict an outcome for a patient, the CI score accounts for effects that comorbidities have on a patient's physiology. In embodiments where a CI score is used, the CI score for a patient may be determined by summing weights assigned to one or more comorbidity variables identified in an electronic medical record associated with the patient. Additionally, in some embodiments, a multiplier may be applied to the summation of weights assigned to the one or more identified comorbidity variables (e.g. summation of weights*10). An example of the one or more comorbidity variables and associated weights for each that are used to determine the CI score are shown in Table 3 above.

In step 540, a predicted outcome for the patient may be determined using the derived pSIS and one or more of the PI score and/or the CI score as variables in an appropriate predictive equation. Exemplary predictive outcomes include: mortality risk, duration of mechanical ventilation, location of stay (e.g. within a health care facility or a specific level of care), readmission risk, discharge destination, and the like.

As can be understood, embodiments of the present invention provide computerized methods and systems for use in, e.g., a healthcare computing environment, for determining a pSIS for a patient admitted to an acute care facility. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims

It will be understood by those of ordinary skill in the art that the order of steps shown in methods 300 of FIG. 3, 400 of FIG. 4, and 500 of FIG. 5 is not meant to limit the scope of the present invention in any way. In fact, the steps may occur in a variety of different sequences within embodiments hereof. Any and all such variations, and any combination thereof, are contemplated to be within the scope of embodiments of the present invention.

What is claimed is:

1. A computer system for determining a patient's severity of illness score (pSIS) for a patient admitted to an acute care healthcare facility, the computer system comprising one or more processors coupled to a computer storage medium, the computer storage medium having stored thereon a plurality of computer software components executable by the one or more processors, the computer software components comprising:
a receiving module that is configured to receive data corresponding to medical support a patient is receiving from an electronic medical record associated with the patient admitted to an acute care facility, the data associated with support variables present in a patient upon admission or administered to the patient within an initial time period from admission;
an identification module that is configured to identify support variables associated with the patient using the received data; and
a determining module that is configured to determine the pSIS for the patient by summing weights associated with each support variable identified.

2. The computer system of claim 1, wherein the initial time period from admission is twenty-four hours.

3. The computer system of claim 1, further comprising a weight module that is configured to assign weights to each support variable identified, the weights associated with each support variable derived using logistic regression coefficients associated with each support variable.

4. The computer system of claim 3, wherein the logistic regression coefficients for each support variable are determined with a final pSIS regression model that predicts the patient's mortality probability.

5. The computer system of claim 4, wherein the final pSIS regression model is derived using a data set corresponding to medical support from an electronic medical record associated with a group of patients admitted to acute care facilities.

6. The computer system of claim 5, wherein the group of patients admitted to acute care facilities includes patients admitted to all levels of care within acute care facilities.

7. The computer system of claim 5, wherein data associated with patients identified as having a probability of in-facility mortality below a minimal threshold is excluded from the data set.

8. The computer system of claim 1, wherein the data associated with support variables includes one or more of anti-arrhythmic medication, antibiotics medication given intravenously, inotrope medication, insulin medication given intravenously, or vasopressor medication given intravenously.

9. The computer system of claim 1, wherein the data associated with support variables includes one or more of dialysis, intubation, invasive mechanical ventilation, non-invasive mechanical ventilation, or pacemaker implanted in the patient.

10. One or more computer hardware storage media having computer-executable instructions embodied thereon that, when executed by a computing device, cause the computing device to perform a method for determining a patient's severity of illness score (pSIS) for a patient admitted to an acute care healthcare facility, the method comprising:
receiving data corresponding to corresponding to medical support a patient is receiving from an electronic medical record associated with the patient admitted to an acute care facility, the data associated with support variables present in a patient upon admission or administered to the patient within an initial time period from admission;
assigning weights to each support variable present, the weights associated with each support variable derived using logistic regression coefficients associated with each support variable; and
determining the pSIS for the patient by summing the weights.

11. The media of claim 10, wherein the method further comprises identifying support variables associated with the patient based on the received data.

12. The media of claim 11, wherein each support variable associated with the patient is identified using medical codes to analyze the received data.

13. The media of claim 12, wherein medical codes include one or more of diagnostic codes, billing codes, procedural codes, topographical codes, pharmaceutical codes.

14. The media of claim 10, wherein the data associated with support variables originates from one or more sources including a clinician's notes, laboratory results, radiologic results, pharmacy records, insurance records.

15. The media of claim 10, wherein the data associated with support variables includes one or more of anti-arrhythmic medication, antibiotics medication given intravenously, inotrope medication, insulin medication given intravenously, vasopressor medication given intravenously, dialysis, intubation, invasive mechanical ventilation, non-invasive mechanical ventilation, or pacemaker implanted in the patient.

16. A method for determining a patient's severity of illness score (pSIS) for a patient admitted to an acute care healthcare facility, the method comprising;
receiving data corresponding to medical support a patient is receiving from an electronic medical record associated with the patient admitted to an acute care healthcare facility, the data associated with support variables present in a patient upon admission or administered to the patient within an initial time period from admission;
identifying support variables associated with the patient using medical codes to analyze the received data; and
determining the pSIS for the patient by summing weights associated with each identified support variable.

17. The method of claim 16, further comprising assigning weights to each identified support variable, the weights associated with each support variable derived using logistic regression coefficients associated with each support variable.

18. The method of claim 16, further comprising determining an overall severity of illness score for the patient using the pSIS as a component.

19. The method of claim 17, further comprising prior to determining the overall SOI score, applying a multiplier to ordinalize the pSIS for use with other physiologic index scores used to determine the overall SOI score.

20. The method of claim 16, wherein the data associated with support variables includes one or more of anti-arrhythmic medication, antibiotics medication given intravenously, inotrope medication, insulin medication given intravenously, vasopressor medication given intravenously, dialysis, intubation, invasive mechanical ventilation, non-invasive mechanical ventilation, or pacemaker implanted in the patient.
